(19) United States
(12) Patent Application Publication
(10) Pub. No.: US 2025/0011896 A1
(43) Pub. Date: Jan. 9, 2025

(54) SYSTEM AND METHOD FOR RECOVERING LITHIUM FROM LITHIUM-CONTAINING FLUIDS USING A FIRST SORBENT AND A SECOND SORBENT

(71) Applicant: EnBW Energie Baden-Württemberg AG, Karlsruhe (DE)

(72) Inventors: Laura Herrmann, Karlsruhe (DE); Thomas Kölbel, Karlsruhe (DE); Elif Kaymakci, Waldbronn (DE); Magdalena Graczyk-Zajac, Heidelberg (DE)

(21) Appl. No.: 18/764,758

(22) Filed: Jul. 5, 2024

(30) Foreign Application Priority Data
Jul. 7, 2023 (DE) 10 2023 118 084.3

(51) Int. Cl. C22B 3/42; B01D 15/16; B01D 15/18; B01D 15/20; B01D 15/36; B01D 15/42; B01J 20/08; B01J 20/34; C22B 3/02; C22B 3/24; C22B 7/00; C22B 26/12; H01M 10/54

(52) U.S. Cl. CPC C22B 3/42; B01D 15/163; B01D 15/1871; B01D 15/203; B01D 15/362; B01D 15/426; B01J 20/08; B01J 20/3433; B01J 20/3475; C22B 3/02; C22B 3/24; C22B 7/006; C22B 26/12; H01M 10/54

(57) ABSTRACT

The disclosure relates to a system (10) for recovering lithium from lithium-containing fluids. It is provided that the system (10) comprises a first container (12) which contains a first sorbent (14) which is designed to bind lithium ions by adsorption, that the system (10) comprises a second container (16) which contains a second sorbent (18) which is designed to bind lithium ions by exchanging hydrogen ions for lithium ions, and that a fluid outlet of the first container (12) is fluidically connected to a fluid inlet of the second container (16).

### BACKGROUND

This disclosure relates to a system for recovering lithium from lithium-containing fluids. Furthermore, this disclosure relates to a method for recovering lithium from lithium-containing fluids.

Due to its advantages such as high electrical energy density, high electrical working voltage, long cyclic service life, lack of memory effect, etc., the rechargeable lithium-ion battery or lithium-ion accumulator is widely used in devices such as laptops, mobile phones and electric cars. The demand for lithium is increasing sharply, partly due to the expansion of electromobility.

It is known to recover lithium from lithium-containing fluids by sorption processes and/or ion exchange processes. For this purpose, the lithium-containing fluid is passed through a sorbent which binds lithium ions present in the fluid. In a subsequent desorption process, the bound lithium ions are desorbed from the sorbent. On the one hand, sorbents that bind lithium ions by adsorption are known (first type of sorbents). An example of such a sorbent is an aluminum layered double hydroxide (Al-LDH). Such sorbents of the first type are typically chemically and mechanically stable, but have the disadvantage that their selective adsorption capacity with regard to lithium ions is limited. This means that in addition to lithium salts, such sorbents typically also adsorb foreign salts such as sodium chloride. The selective adsorption of lithium salts using such sorbents in the presence of other foreign salts such as sodium salts is therefore only possible to a limited extent.

In addition, sorbents are also known that bind lithium ions by exchanging bound hydrogen ions or protons for lithium ions (second type of sorbents). Examples of such sorbents are lithium titanium oxide or lithium manganese oxide. Such sorbents have a high degree of selectivity for lithium ions. However, compared to, for example, an aluminum layered double hydroxide, they are less chemically and mechanically stable. Accordingly, during the desorption step involving lithium extraction on the basis of an ion exchange process, some of the sorbent may decompose and be lost.

In known systems and processes, either a sorbent of the one type or a sorbent of the other type is typically used to recover lithium. Such a system and such a method are described, for example, in laid-open application EP 4 063 527 A1. However, this is accompanied by the disadvantages previously discussed in connection with the two types of sorbents.

### SUMMARY

The object of the disclosure is to provide a system and a method for recovering lithium from lithium-containing fluids, in which the disadvantages of the two types of sorbents discussed above are at least largely overcome. For this purpose, a cascaded system and a corresponding method are proposed here.

This object is achieved according to the disclosure by a system having the features of claim 1 and by a method having the features of claim 8. The respective dependent claims and the description indicate advantageous variants and embodiments.

According to the disclosure, a system is thus provided for recovering lithium from lithium-containing fluids. The system comprises a first container that contains a first sorbent which is designed to bind lithium ions by adsorption. During an adsorption process, the adsorbed material accumulates on a boundary surface of the sorbent and/or is incorporated into a layer structure of the sorbent. The first sorbent present in the first container is designed to bind lithium ions by means of adsorption. Adsorption therefore forms at least the predominant mechanism with regard to binding lithium or lithium ions by means of the first sorbent. Preferably, the first container is designed as a column. A column is a column-shaped container. Preferably, the first sorbent adsorbs the lithium ions as lithium salt, i.e. together with associated anions. Depending on the lithium-containing fluid, these can be different anions, e.g. chloride ions or sulphate ions. Lithium chloride or lithium sulphate is then accordingly adsorbed.

The system according to the disclosure also comprises a second container that contains a second sorbent which is designed to bind lithium ions by exchanging bound hydrogen ions for lithium ions. The second sorbent thus initially contains hydrogen ions and is designed to exchange the bound hydrogen ions for lithium ions so that the second sorbent acts as a cation exchanger. The exchange of bound hydrogen ions for lithium ions forms at least the predominant mechanism with regard to binding lithium or lithium ions by means of the second sorbent. Preferably, the second container is designed as a column.

According to the disclosure, a fluid outlet of the first container is fluidically connected to a fluid inlet of the second container. Fluid flowing out of the first container can be accordingly fed to the second container.

The system according to the disclosure enables an advantageous recovery of lithium from lithium-containing fluids, wherein the disadvantages of the sorbents used are at least largely overcome. For this purpose, a lithium-containing raw fluid can first be fed to the first container which contains the first sorbent. The first sorbent then binds lithium ions by adsorbing lithium ions present in the raw fluid. In addition, certain foreign salts such as sodium chloride are also adsorbed by the first sorbent. However, not all components of the raw fluid are adsorbed by the first sorbent and therefore coarse cleaning can be achieved by the first sorbent. Most of the components of the raw fluid remain in the raw fluid and are discharged from the first container together with the raw fluid. A desorption fluid can then be fed to the first container to desorb the adsorbed lithium ions. Typically, the adsorbed foreign salts are also desorbed in the process. The desorption fluid then enriched with lithium ions can then be fed to the second container or the second sorbent present therein. This is easily possible due to the fluidic connection of the fluid outlet of the first container to the fluid inlet of the second container. At the end of the first process (adsorption by means of the first sorbent and subsequent desorption), a purer solution with a higher lithium content compared to the raw fluid is obtained, which allows the second process (uptake of lithium ions by the second sorbent and subsequent desorption) to perform more efficient extraction. In addition, the implementation of coarse cleaning enables the protection of the chemically and mechanically unstable second sorbent from pressure and temperature fluctuations since the second container can be decoupled from the raw fluid. The second sorbent has a significantly higher degree of selectivity with regard to binding lithium ions and therefore fine cleaning can be achieved in the second container. Because coarse cleaning has already taken place beforehand and a purer solution is fed to the second container, the second sorbent is protected. The components of the raw fluid separated from the lithium during the coarse cleaning process do not come into contact with the second sorbent.

In some preferred embodiments, it is provided that the first sorbent is an aluminum oxide-based sorbent. Aluminum oxide-based sorbents are particularly chemically and mechanically stable. This makes it possible, for example, to pass the raw fluid through the first container using overpressure, which can increase lithium recovery efficiency. The aluminum oxide-based first sorbent is particularly preferably a layered double hydroxide (LDH) with the chemical formula LiₓAl₂(OH)₆Clₓ·n H₂O, e.g. LiCl·Al₂(OH)₆·n H₂O.

In some preferred embodiments, it is provided that the second sorbent is a manganese oxide-based sorbent or a titanium oxide-based sorbent. Such sorbents exhibit high selectivity with regard to binding lithium ions. Particularly preferably, the manganese oxide-based sorbent is a sorbent having the chemical formula HₓMn_{y}O_{z}, e.g. H_{1.6}Mn_{1.6}O₄. Particularly preferably, the titanium oxide-based sorbent is a sorbent having the chemical formula HₓTi_{y}O_{z}, e.g. H₂TiO₃.

In some preferred embodiments, it is provided that the fluid outlet of the first container or another fluid outlet of the first container is fluidically connected to an injection bore so that a fluid flowing out of the first container can be fed to either the second container or to the injection bore. Due to the fluidic connection with the injection bore, the raw fluid can be easily fed to the injection bore after passing through the first container. Since the raw fluid is not acidified by the adsorption process that takes place using the first sorbent, pH regulation is typically not necessary.

In some preferred embodiments, it is provided that a fluid outlet of the second container is fluidically connected to a fluid inlet of the first container. This results in the advantage that fluid flowing out of the second container can be fed to the first container, for example in order to use the fluid for a desorption process in the first container.

In some preferred embodiments, it is provided that the fluid outlet of the second container is fluidically connected to the fluid inlet of the first container by a demineralization unit. For desorption processes in the first container, fluids that have a low salt content are preferred. In this respect, the demineralization unit has the advantage that the suitability of the fluid flowing out of the second container for desorption processes is improved.

In some preferred embodiments, it is provided that the demineralization unit has at least one osmosis membrane and/or that the demineralization unit has at least one sorbent. The demineralization unit can effectively reduce the salt content of fluids by means of an osmosis membrane or a sorbent.

The method according to the disclosure for recovering lithium from lithium-containing fluids comprises at least the following:

Passing a lithium-containing raw fluid through a first sorbent, wherein the first sorbent binds lithium ions by means of adsorption so that a first sorbent enriched with lithium ions is obtained. Adsorption forms at least the predominant mechanism with regard to binding lithium ions by means of the first sorbent. Preferably, an aluminum oxide-based sorbent is used as the first sorbent. Since the first sorbent binds lithium ions by adsorption, the pH value of the raw fluid is at most slightly changed upon passing through the first sorbent. Preferably, the raw fluid is fed to an injection bore after passing through the first sorbent, whereby prior pH regulation of the raw fluid is preferably dispensed with. For example, a lithium-containing brine or a lithium-containing battery recycling solution can be used as the lithium-containing raw fluid.

Passing a desorption fluid through the first sorbent enriched with lithium ions, wherein adsorbed lithium ions are desorbed so that a desorption fluid enriched with lithium ions is obtained. Preferably, low-salt water, in particular distilled water, is used as the desorption fluid. Low-salt water has high effectiveness with regard to the desorption of adsorbed lithium ions. A low-concentration lithium chloride solution can also be used as the desorption fluid. This has the advantage that the stability of the material is increased.

Passing the desorption fluid enriched with lithium ions through a second sorbent, wherein the second sorbent binds lithium ions by exchanging lithium ions for hydrogen ions so that a second sorbent enriched with lithium ions and a desorption fluid low in lithium ions are obtained. The binding of lithium ions by exchanging bound hydrogen ions for lithium ions forms at least the predominant mechanism with regard to binding lithium ions by means of the second sorbent. Preferably, a manganese oxide-based sorbent or a titanium oxide-based sorbent is used as the second sorbent. Such sorbents are characterized by their high degree of selectivity with regard to binding lithium ions compared to binding, for example, sodium ions.

Passing an acidic elution fluid through the second sorbent enriched with lithium ions, wherein bound lithium ions are desorbed by being exchanged for hydrogen ions, so that an elution fluid enriched with lithium ions is obtained. This exchange process is promoted by the high concentration of hydrogen ions or protons in the acidic elution fluid.

The method according to the disclosure enables an advantageous recovery of lithium from lithium-containing fluids. Coarse cleaning is achieved by the first sorbent, in which lithium salts and certain foreign salts such as sodium chloride are separated from other components of the raw fluid by adsorption. The first sorbent is well suited for this due to its chemical and mechanical stability. Fine cleaning is then achieved by the second sorbent, during which lithium is also separated from foreign salts such as sodium chloride due to the high degree of selectivity of the second sorbent.

As previously mentioned, it is advantageous if a low-concentration lithium chloride solution is used as the desorption fluid. Particularly preferably, a mixture is used as the desorption fluid which comprises low-salt water, in particular distilled water, and additionally desorption fluid enriched with lithium ions, i.e. the fluid obtained in method step b., and/or elution fluid enriched with lithium ions, i.e. the fluid obtained in method step d. Desorption fluid enriched with lithium ions and/or elution fluid enriched with lithium ions are therefore used as a component of the desorption fluid in a subsequent desorption process.

Preferably, the method is carried out by means of a system as described above for recovering lithium from lithium-containing fluids.

Advantages and possible developments of the system are to be understood as also being described in relation to the method, and, vice versa, advantages and possible developments of the method are to be understood as also being described in relation to the device.

In some preferred embodiments of the method, it is provided that the lithium-containing raw fluid is passed through the first sorbent under a pressure of at least 2 bar. This can increase the efficiency of the method. The chemically and mechanically stable first sorbent is at most slightly damaged by the overpressure. Preferably, the raw fluid is passed through the first sorbent under a pressure of at least 2 bar and at most 50 bar, preferably under a pressure of at least 5 bar, preferably under a pressure of at least 5 bar and at most 50 bar, particularly preferably under a pressure of at least 10 bar and at most 30 bar.

In some preferred embodiments of the method, it is provided that the desorption fluid enriched with lithium ions is passed through the second sorbent under atmospheric pressure. As previously mentioned, the second sorbent is typically less mechanically stable, so passing it through under atmospheric pressure protects the second sorbent. Since coarse cleaning by the first sorbent has already taken place, the desorption fluid enriched with lithium ions typically has a higher lithium ion concentration than the raw fluid, and therefore despite the use of atmospheric pressure and the associated lower flow velocity, a time-efficient recovery of lithium can still be achieved.

In some preferred embodiments of the method, it is provided that the acidic elution fluid comprises hydrochloric acid, sulfuric acid and/or acetic acid. It has been shown that these acids are particularly suitable for displacing lithium ions from the second sorbent.

In some preferred embodiments of the method, the concentration of acid in the acidic elution fluid is between 0.01 mol/l and 5 mol/l. This refers to the concentration of the acidic elution fluid before being passed through the second sorbent. It has been shown that this concentration range enables a time-efficient displacement of lithium ions from the second sorbent. At the same time, minor damage to the second sorbent occurs at most.

In some preferred embodiments of the method, it is provided that the desorption fluid passed through the second sorbent, which fluid is then low in lithium ions, is reused as desorption fluid. By reusing the desorption fluid, the overall requirement for desorption fluid can be reduced. Preferably, the salt content of the desorption fluid passed through the second sorbent, which fluid is then low in lithium ions, is reduced before it is reused. To accomplish this, for example, the desorption fluid, which is passed through the second sorbent and is then low in lithium ions, is passed through an osmosis membrane and/or through another sorbent.

In some preferred embodiments of the method, it is provided that the acidic elution fluid is passed through the second sorbent several times. The acidic elution fluid is therefore used in several successive desorption processes, wherein between two successive desorption processes, desorption fluid enriched with lithium ions is preferably again passed through the second sorbent in order to load the second sorbent with lithium ions. By repeatedly using the acidic elution fluid, the lithium ion concentration in the acidic elution fluid can be increased. In addition, only a small amount of acidic elution fluid is required overall. If necessary, the pH of the acidic elution fluid can be adjusted between successive desorption processes by adding acid.

### BRIEF DESCRIPTION OF THE DRAWINGS

The disclosure will be described in more detail below with reference to the figures, the same or functionally equivalent elements possibly being provided with reference signs only once. The description serves as an example and is not to be understood as limiting. In the drawings:

FIG. 1 is a schematic view of a system for recovering lithium from lithium-containing fluids; and

FIG. 2 shows a method for recovering lithium from lithium-containing fluids.

### DETAILED DESCRIPTION

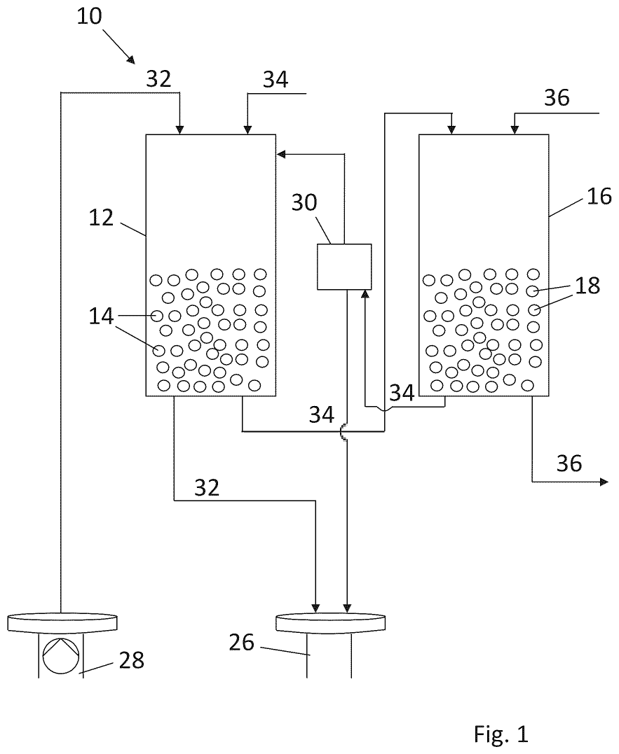

FIG. 1 is a schematic view of a system 10 for recovering lithium from lithium-containing fluids. In particular, fluid outlets, fluid inlets and fluid lines are not shown in detail in FIG. 1, but are only indicated schematically. In the present example, the fluid contains lithium in the form of lithium chloride. However, depending on the composition of the fluid, other types of lithium salts can also be obtained.

The system 10 comprises a first container 12 which contains a first sorbent 14. The first sorbent 14 is present as a solid. The first container 12 is designed as a column. In the embodiment shown in FIG. 1, the interior of the first container 12 is only partially filled with the first sorbent 14. The first sorbent 14 is designed to bind lithium ions by adsorption. Preferably, the first sorbent 14 is an aluminum oxide-based sorbent.

The system 10 also comprises a second container 16 that contains a second sorbent 18. The second sorbent 18 is also present as a solid. The second container 16 is designed as a column. In the embodiment shown in FIG. 1, the interior of the second container 16 is only partially filled with the second sorbent 18. The second sorbent 18 is designed to bind lithium ions by exchanging bound hydrogen ions for lithium ions. The second sorbent 18 therefore acts as a cation exchanger with regard to binding lithium ions. Preferably, the second sorbent 18 is a manganese oxide-based sorbent or a titanium oxide-based sorbent.

The first container 12 is fluidically connected on the outlet side to a fluid inlet of the second container 16. The first container 12 is also fluidically connected to an injection bore 26 on the outlet side. Accordingly, fluid flowing out of the first container 12 can either be fed to the second container 16 or to the injection bore 26.

The second container 16 is fluidically connected on the outlet side to a fluid inlet of the first container 12. Fluid flowing out of the second container 16 can be accordingly fed to the first container 12. In the present case, the second container 16 is fluidically connected to the fluid inlet of the first container 12 via a demineralization unit 30.

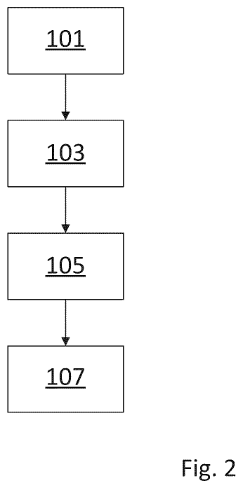

In the following, with additional reference to FIG. 2, an advantageous method for recovering lithium from lithium-containing fluids shall be explained in more detail. FIG. 2 shows the method using a flow chart. The method is carried out by means of the system 10 shown in FIG. 1.

In a first step 101, a lithium-containing raw fluid 32 is passed through the first sorbent 14. Passing a fluid through a sorbent involves introducing the fluid into the relevant container and it then flowing out of the container. In this case, thermal water, which was taken from a production bore 28, is used as the raw fluid 32. Lithium ions present in the raw fluid 32 are adsorbed by the first sorbent 14 while passing through the first sorbent 14. Accordingly, a first sorbent 14 enriched with lithium ions and a raw fluid 32 low in lithium ions are obtained. The raw fluid 32 low in lithium ions is fed to the injection bore 26.

Preferably, the lithium-containing raw fluid 32 is passed through the first sorbent 14 under a pressure that exceeds atmospheric pressure, particularly preferably under a pressure of at least 10 bar and at most 30 bar.

In a second step 103, a desorption fluid 34 is passed through the first sorbent 14 enriched with lithium ions. Preferably, low-salt water is used as the desorption fluid 34. The desorption fluid 34 desorbs lithium ions adsorbed by the first sorbent 14 upon passing through the first sorbent 14. Accordingly, the first sorbent 14 is regenerated, and a desorption fluid 34 enriched with lithium ions is obtained.

Coarse cleaning is realized by method steps 101 and 103. In particular, the lithium ions present in the raw fluid 32 are separated from components of the raw fluid 32 that could damage the second sorbent 18. However, during coarse cleaning, the lithium is not separated from foreign salts such as sodium chloride which are equally adsorbed by the first sorbent 14.

In a third method step 105, the desorption fluid 34 enriched with lithium ions is passed through the second sorbent 18. Due to the fluidic connection between the first container 12 and the second container 16, the desorption fluid 34 can be easily supplied to the second container 16. The second sorbent 18 binds lithium ions present in the desorption fluid 34 by exchanging bound hydrogen ions for lithium ions. Accordingly, a second sorbent 18 enriched with lithium ions is obtained. A desorption fluid 34 low in lithium ions flows out of the second container 16.

In a fourth method step 107, an acidic elution fluid 36 is passed through the second sorbent 18 enriched with lithium ions. Lithium ions bound to the second sorbent 18 are exchanged for hydrogen ions present in the elution fluid 36. Accordingly, the second sorbent 18 is regenerated, and an elution fluid 36 enriched with lithium ions is obtained.

Preferably, the acidic elution fluid 36 comprises hydrochloric acid, sulfuric acid and/or acetic acid as the acid. The concentration of acid in the acidic elution fluid 36 is preferably between 0.01 mol/l and 5 mol/l, at least before the elution fluid 36 passes through the second sorbent 18.

Fine cleaning is realized by method steps 105 and 107. Specifically, by means of method steps 105 and 107, lithium ions are also separated from foreign salts such as sodium chloride which are also adsorbed by the first sorbent 14. This results from the high degree of selectivity of the second sorbent 18 for lithium ions.

In the system 10 shown in FIG. 1 or the method shown in FIG. 2, the desorption fluid 34 flowing out of the second container 16 is fed to the first container 12 once again and is therefore reused. This has the advantage that the overall amount of desorption fluid 34 required can be reduced. As previously mentioned, the use of a low-salt desorption fluid is preferred for the desorption of lithium ions. In order to reduce the salt content of the desorption fluid 34 flowing out of the second container 18, the desorption fluid 34 is first fed to the demineralization unit 30 before being reused. The demineralization unit 30 reduces the salt content of the desorption fluid 34. For this purpose, the demineralization unit 30 comprises, for example, at least one osmosis membrane and/or at least one sorbent. An additionally obtained fraction of the desorption fluid 34 with a high salt concentration can be fed to the injection bore 26.

Preferably, the acidic elution fluid 36 is passed through the second sorbent 18 several times. Thus, several desorption processes are carried out with the same elution fluid 36. Between successive desorption processes, the second sorbent 18 is reloaded with lithium ions by passing through desorption fluid 34 enriched with lithium ions. By using the elution fluid 36 several times, more effective use is made of the uptake capacity of the elution fluid 36 for lithium ions, and an elution fluid 36 with a high lithium ion concentration is ultimately obtained.

Persons skilled in the art will understand that the structures and methods specifically described herein and illustrated in the accompanying figures are non-limiting exemplary aspects, and that the description, disclosure, and figures should be construed merely as exemplary of particular aspects. It is to be understood, therefore, that this disclosure is not limited to the precise aspects described, and that various other changes and modifications may be effectuated by one skilled in the art without departing from the scope or spirit of the disclosure. Additionally, it is envisioned that the elements and features illustrated or described in connection with one exemplary aspect may be combined with the elements and features of another without departing from the scope of this disclosure, and that such modifications and variations are also intended to be included within the scope of this disclosure. Indeed, any combination of any of the disclosed elements and features is within the scope of this disclosure. Accordingly, the subject matter of this disclosure is not to be limited by what has been particularly shown and described.

What is claimed is:

1. A system (10) for recovering lithium from lithium-containing fluids, comprising at least:
a first container (12), in particular a first column (12), which contains a first sorbent (14) that is designed to bind lithium ions by adsorption, and a second container (16), in particular a second column (16), which contains a second sorbent (18) that is designed to bind lithium ions by exchanging bound hydrogen ions for lithium ions, and wherein a fluid outlet of the first container (12) is fluidically connected to a fluid inlet of the second container (16).

2. The system (10) according to claim 1, characterized in that the first sorbent (14) is an aluminum oxide-based sorbent.

3. The system (10) according to claim 1, characterized in that the second sorbent (18) is a manganese oxide-based sorbent or a titanium oxide-based sorbent.

4. The system (10) according to claim 1, characterized in that the fluid outlet of the first container (12) or another fluid outlet of the first container (12) is fluidically connected to an injection bore (26) so that a fluid flowing out of the first container (12) can be fed to either the second container (16) or to the injection bore (26).

5. The system (10) according to claim 1, characterized in that a fluid outlet of the second container (16) is fluidically connected to a fluid inlet of the first container (12).

6. The system (10) according to claim 5, characterized in that the fluid outlet of the second container (16) is fluidically connected to the fluid inlet of the first container (12) by a demineralization unit (30).

7. The system (10) according to claim 6, characterized in that the demineralization unit (30) has at least one osmosis membrane, and/or that the demineralization unit has at least one sorbent.

8. A method for recovering lithium from lithium-containing fluids, in particular by a system (10) according to claim 1, at least comprising:
a. Passing a lithium-containing raw fluid (32), in particular lithium-containing brine or lithium-containing battery recycling solution, through a first sorbent (14), wherein the first sorbent (14) binds lithium ions by adsorption so that a first sorbent (16) enriched with lithium ions is obtained;
b. passing a desorption fluid (34) through the first sorbent (14) enriched with lithium ions, wherein adsorbed lithium ions are desorbed so that a desorption fluid (34) enriched with lithium ions is obtained;
c. passing the desorption fluid (34) enriched with lithium ions through a second sorbent (18), wherein the second sorbent (18) binds lithium ions by exchanging bound hydrogen ions for lithium ions so that a second sorbent (18) enriched with lithium ions and a desorption fluid (34) low in lithium ions are obtained; and
d. passing an acidic elution fluid (36) through the second sorbent (18) enriched with lithium ions, wherein bound lithium ions are desorbed by being exchanged for hydrogen ions so that an elution fluid (36) enriched with lithium ions is obtained.

9. The method according to claim 8, characterized in that the lithium-containing raw fluid (32) is passed through the first sorbent (14) under a pressure of at least 2 bar, preferably under a pressure of at least 2 bar and at most 50 bar, preferably under a pressure of at least 5 bar, preferably under a pressure of at least 5 bar and at most 50 bar, particularly preferably under a pressure of at least 10 bar and at most 30 bar.

10. The method according to claim 8, characterized in that the desorption fluid (34) enriched with lithium ions is passed through the second sorbent (18) under atmospheric pressure.

11. The method according to claim 8, characterized in that the acidic elution fluid (36) comprises hydrochloric acid, sulfuric acid and/or acetic acid.

12. The method according to claim 8, characterized in that the concentration of acid in the acidic elution fluid (36) is between 0.01 mol/l and 5 mol/l.

13. The method according to claim 8, characterized in that the desorption fluid (34) passed through the second sorbent (18), which fluid is then low in lithium ions, is reused as desorption fluid (34).

14. The method according to claim 8, characterized in that the acidic elution fluid (36) is passed through the second sorbent (18) several times.
